(19) United States
(12) Patent Application Publication
(10) Pub. No.: US 2008/0272989 A1
(43) Pub. Date: Nov. 6, 2008

(54) Light Emission Panel Display Device

(75) Inventors: Toshiro Takahashi, Kanagawa (JP); Atsuo Ishizuka, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO.,, Kanagawa (JP)

(21) Appl. No.: 11/547,194

(22) PCT Filed: Mar. 30, 2004
(86) PCT No.: PCT/JP04/04483

§ 371 Date: Feb. 8, 2007

(51) Int. Cl. G09G 3/30

(52) U.S. Cl. 345/76

(57) ABSTRACT

The light emission panel display device according to the present invention has a scan drive circuit (30) driving a selected scan line to a selected voltage and unselected scan lines to a non-selected voltage higher than the selected voltage in each scanning period and (3) a data drive circuit (20) supplying light-emitting drive current to the data lines respectively in the periods of light emission corresponding to display gradation. The data drive circuit (20) starts supply of the light-emitting drive current to the data lines respectively at the emission-initiation timing corresponding to the emission period in the scanning period, and terminates supply of the light-emitting drive current to the multiple data lines at the same emission-termination timing. In addition, the scan drive circuit (30) maintains the selected scan line to an emission-termination voltage higher than the selected voltage and terminates light emission of the light-emitting element connected to the selected scan line at the emission-terminating timing. It is thus possible to prevent continuous light emission of the light-emitting element emitting light by electrical charging and discharging at the emission-termination timing during light emission.

### TECHNICAL FIELD

The present invention relates to a light emission panel display device, using a capacitive light-emitting element such as an organic electroluminescence (EL) element, that improves the gradation characteristics of luminescence brightness for gradient values and raises the quality of images.

### BACKGROUND ART

Light emission panel display devices using a capacitive light-emitting element such as an organic EL element, have a simple structure allowing a reduction in thickness, do not need to have backlight in the same way as liquid crystal display panels do because the element in each pixel emits light by itself, and are attracting attention as thin low-power consumption display panels.

FIG. 1 is a chart showing the configuration of a light emission panel display device in a conventional capacitive light-emitting element. Such light emission panel display devices are described, for example, in Japanese Patent Application Laid-Open (JP-A) Nos. 2000-140037 and H11-311978. As shown in the figure, an organic EL element contains capacitive elements and elements having diode characteristics in parallel with the capacitive elements; and, the capacitive element is charged when a direct-current light-emitting drive voltage is applied between the anode and the cathode thereof, and when the voltage applied between the electrodes becomes larger than the emission threshold voltage for an element, electric current flows in the light-emitting layer and the organic EL element emits light.

The light emission panel display device shown in FIG. 1 has a light emitting panel 10 carrying light-emitting elements A11 to Ann placed in a matrix shape, a data drive circuit 20 driving data lines B1 to Bn on the light emitting panel, and a scan drive circuit 30 driving scan lines C1 to Cn on the light emitting panel. The data drive circuit 20 also has switches D1 to Dn for grounding the data lines B1 to Bn respectively or connecting them to a light-emitting drive voltage Vd1. The scan drive circuit 30 has switches S1 to Sn for connecting the scan lines C1 to Cn respectively to the ground voltage in the selected level or the reverse biased voltage Vs in the unselected level. In the switching state of the drive circuit shown in FIG. 1, the scan line C1 is in the selected state as it is grounded and the other scan lines C2 to Cn are in the unselected state as they are connected to the reverse biased voltage Vs, and the data lines B1 to Bn are respectively connected to the light-emitting drive voltage Vd1. In this state the light-emitting drive current flows from the data lines B1 to Bn, via the light-emitting element A11 to A1n, through the scan line C1, and the light-emitting elements A11 to A1n connected to the selected scan line C1 emit light. After light emission from the scan line C1, the next scan line C2 is selected by grounding and the other scan lines C1 and C3 to Cn are unselected by connecting to the reverse biased voltage, and the light-emitting drive voltage Vd1 is applied to the data lines B1 to Bn.

In the scanning period (horizontal synchronization period) of each scan line in the selected state, application of the light-emitting drive voltage Vd1 to each data line is controlled to a period of time according to the gradation of the inputted image signal. That is, a control pulse controlling application of the light-emitting drive voltage Vd1 of the data drive circuit 20 has a pulse width according to the gradation of the image signal, and the light-emitting drive current is supplied to the data line for the period of time corresponding to the image signal gradation in response to the control pulse modulated by pulse width of the image signal gradient value, making the light-emitting element emit light.

FIG. 2 is a chart showing examples of the control pulse and the light-emitting waveform generated in the data drive circuit of the light emission panel display device shown in FIG. 1. In the scanning period (horizontal synchronization period) Hsync, a control pulse CP1 for switching the drive switch D1 in the data drive circuit 20 to the light-emitting drive voltage Vd1 and a control pulse CP2 for switching the drive switch D2 similarly are applied simultaneously, and the control pulses CP1 and CP2 are terminated, respectively, after periods of time according to the pulse width PW (A11) corresponding to the gradation of the light-emitting element A11 and the pulse width PW (A12) corresponding to the gradation of the light-emitting element A12. In this way, the display brightness is adjusted according to the gradation of the image signal, by controlling the period of time of emission of the light-emitting element according to the gradation of the image signal while emitting light in response to the control pulse modified in width from the inputted image signal. In such a case, the light-emitting elements A11 and A12 emit light in the light-emitting waveform shown in the Figure during the period when the control pulses CP1 and CP2 are applied.

FIG. 3 is a chart showing the problems encountered in conventional devices. FIG. 3(A) shows a state in which a light-emitting drive voltage Vd1 is applied to the data line B1 in response to the control pulse CP1, while FIG. 3(B) shows a state in which application of the light-emitting drive voltage Vd1 is terminated after completion of the control pulse CP1. The selected scan line C1 is grounded in the selected level and the data line B1 is connected to the light-emitting drive voltage Vd1 in the state shown in FIG. 3(A), and a light-emitting current IL flows through the light-emitting element A11. The unselected scan lines C2 to Cn are connected to the reverse biased voltage Vs in the unselected level, and the diode elements in the light-emitting elements A21 to An1 are reverse biased, and the capacitive elements are charged under the differential voltage (Vs−Vd1) between the reverse biased voltage Vs and the light-emitting drive voltage Vd1. As shown in FIG. 3(B), from this state, when application of the control pulse CP1 is terminated and the data line B1 is set to a floating state in the data drive circuit 20, all of the electric charge charged to the unselected light-emitting elements A21 to An1 connected to the data line B1 flow into the selected light-emitting element A11, allowing it to emit light, and not giving an immediate termination of light emission, although the period of continued light emission is extremely short. As a result, because of the electric current, the light-emitting waveform of the light-emitting element A11 does not disappear immediately in response to termination of the control pulses CP1 and CP2, as indicated by reference numbers 40 in FIG. 2. Such slowness in response results in a deterioration in the linearity of the gradation characteristics of the light-emitting element, i.e., elongation of the emission period from the pulse width of the control pulse corresponding to the image signal gradient value and an increase in the luminescence brightness. The data line being controlled into the floating state after application of the control pulse, an be thought of as preventing undesirable waste discharge of the electric charges charged in the light-emitting element.

To solve the problems above, the data drive circuit 20 in the previous patent (JP-A No. 2002-140037) described above has terminals for grounding and to a light-emitting drive voltage Vd1 and also a third voltage terminal, and, after application of the light-emitting drive voltage Vd1 to data line B1, the data line B1 is not made in the floating state but connected to the third voltage terminal. And, the third voltage V3 is controlled to an electric potential level in which the third voltage satisfies a relationship with the emission threshold voltage Vth of V3<Vth. It is thus possible to prevent flow of discharge electric charges from other light-emitting elements into the light-emitting element A11, by connecting the data line B1 to the third voltage at the point in time when supply of the light-emitting drive current IL to light-emitting element A11 by application of the light-emitting drive voltage Vd1 to data line B1 is terminated.

### DESCRIPTION OF THE INVENTION

However, the driving method above, which demands connection of the data line B1 to the third voltage V3 during the period from termination of application to control pulses CP1 and CP2 to the end of horizontal synchronization period Hsync, causes a problem of increase in electric current consumption, especially during low-gradation operation. In addition, it is necessary to connect all data lines B1 to Bn to the third voltage V3, which causes consumption of greater electric current. Further, it also demands an additional voltage-generating circuit for generating the third voltage for the data drive circuit 20, causing a problem in expansion in size of the data drive circuit.

Accordingly, an object of the invention is to provide a light emission panel display device resistant to deterioration in the linearity of gradation characteristics.

Another object of the invention is to provide a light emission panel display device that allows reduction of undesirable power consumption and is yet resistant to deterioration in the linearity of gradation characteristics.

A first aspect of the invention is a light emission panel display device, comprising (1) a light emitting panel having multiple scan lines, multiple data lines, and capacitive light-emitting elements connected to the data lines and the scan lines at the intersections of the scan lines and the data lines, (2) a scan drive circuit scanning and selecting the scan lines sequentially and in each scanning period driving the a selected scan line to a selected voltage and driving the unselected scan lines to a non-selected voltage higher than the selected voltage and (3) a data drive circuit supplying a light-emitting drive current to each data line during the light-emitting period corresponding to each display gradation. The data drive circuit, in the scanning period, initiates supply of the light-emitting drive current to the data lines at respective emission-initiation timings corresponding to the emission period and terminates supply of the light-emitting drive current to the multiple data lines at respective emission-termination timing. The scan drive circuit drives the selected scan line to the emission-termination voltage higher than the selected voltage at the emission-termination timing and terminates emission of the light-emitting elements connected to the selected scan line.

According to the first aspect of the invention, emission of the light-emitting element is terminated by prohibiting application of a voltage not lower than the emission threshold voltage to the light-emitting element while harmonizing the emission-termination timings to all light-emitting elements and connecting the selected scan line to the selected voltage higher emission-termination voltage at the emission-termination timing. It is thus possible to improve gradation characteristics. It also leads to reduction in power consumption, because only the selected scan line is driven.

In a preferable embodiment of the first aspect of the invention, the data drive circuit makes the data lines enter into a floating state after the emission-termination timing. Thus, it is possible to eliminate the need for driving the data lines and thus, to reduce the amount of power consumption.

### BRIEF DESCRIPTION OF THE DRAWINGS

FIG. 1 is a chart showing the configuration of a light emission panel display device in conventional capacitive light-emitting elements.

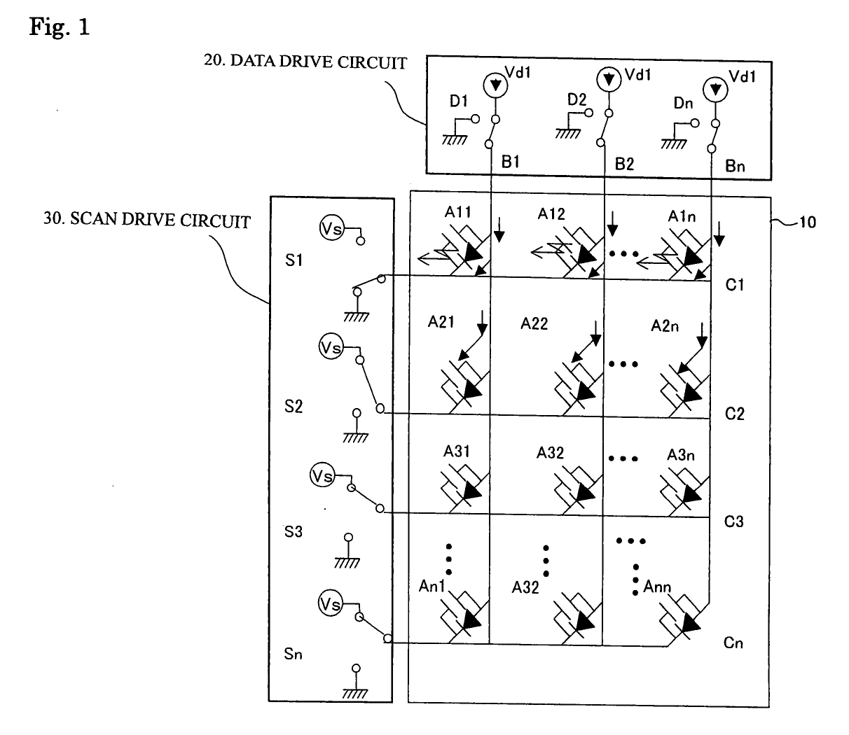

FIG. 2 is a chart showing examples of the control pulse and the light-emitting waveform generated in the data drive circuit of the light emission panel display device shown in FIG. 1.

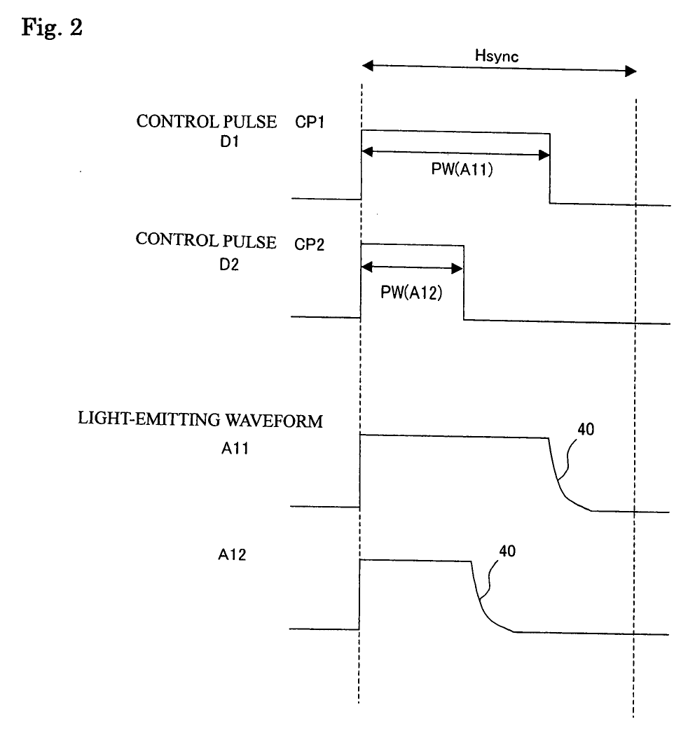

FIG. 3 is a chart showing traditional problems.

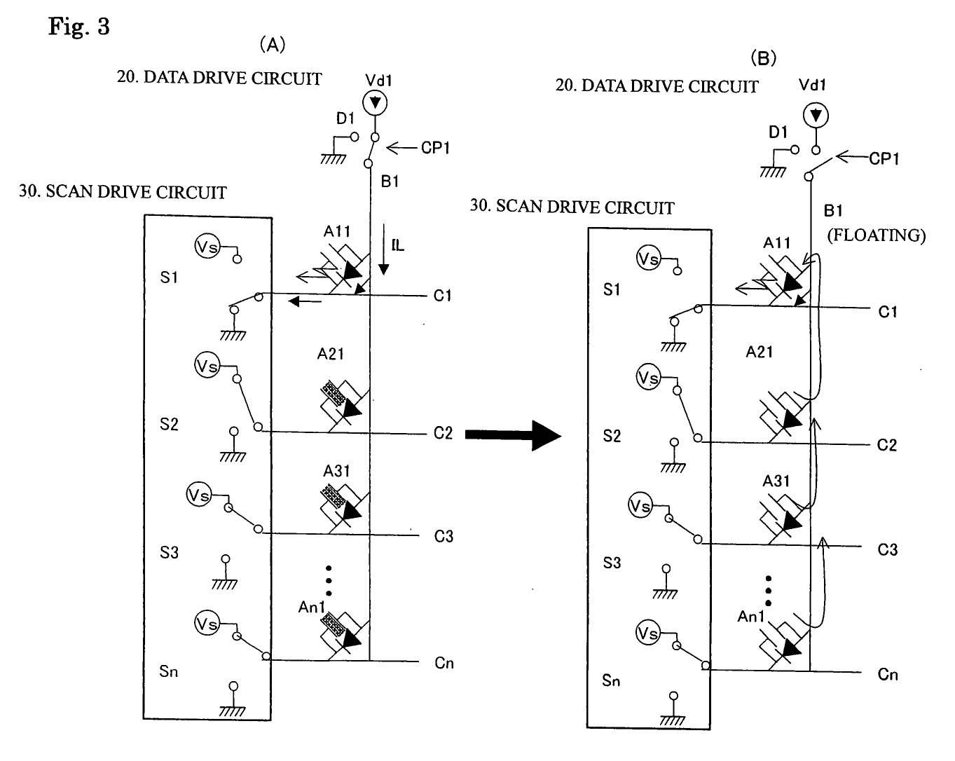

FIG. 4 is a chart showing the configuration of the light emission panel display device in an embodiment.

FIG. 5 is a chart showing the configuration of the light emission panel display device in another embodiment.

FIG. 6 is a chart showing the configuration of the light emission panel display device in yet another embodiment.

FIG. 7 is a chart showing the example of the drive waveform in the light emission panel display device in the embodiment above.

FIG. 8 is a chart explaining the operations performed at the emission-termination timing showing in the embodiment.

FIG. 9 is a chart showing the drive waveform in a modification of the embodiments above.

FIG. 10 is a chart showing the control pulse-generating circuit in the embodiment.

FIG. 11 is a chart showing the drive waveform in another modification (2) of the embodiment above.

FIG. 12 is a chart showing the drive waveform in another modification (3) of the embodiment above.

FIG. 13 is a chart showing the drive waveform in another modification (4) of the embodiment above.

### BEST MODE OF CARRYING OUT THE INVENTION

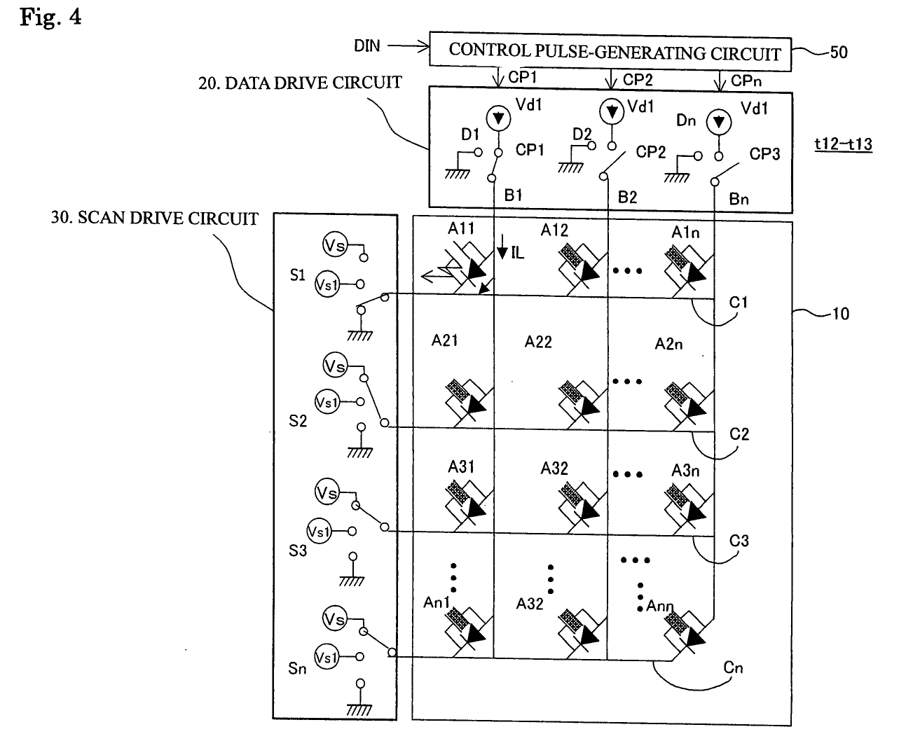

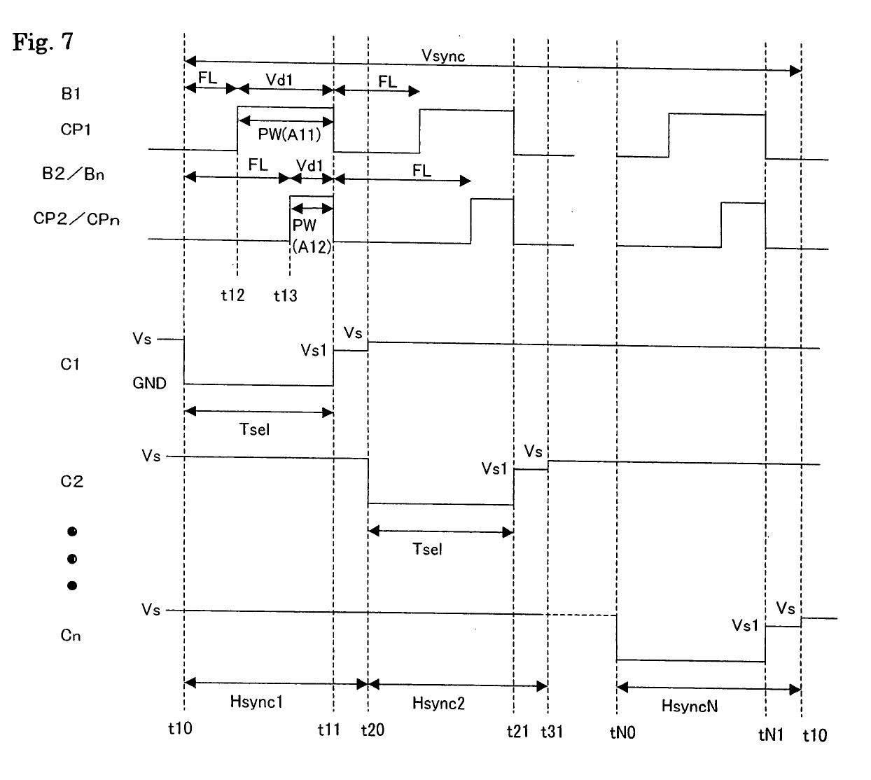

Hereinafter, favorable embodiments of the present invention will be described with reference to drawings. FIGS. 4, 5, and 6 are charts illustrating the configuration of the light emission panel display device in the embodiment. Each of these figures shows the switching state of drive circuit at a time different from each other in the scanning period. FIG. 7 is a chart showing drive waveforms in the light emission panel display device in the embodiment. As shown in FIGS. 4 to 6, the light emission panel display device has light-emitting elements A11 to Ann connected to the intersections between data lines B1 to Bn and scan lines C1 to Cn. In addition, the light emission panel display device has a control pulse-generating circuit 50 generating control pulses CP1 to CPn, and switches D1 to Dn supplying a light-emitting drive current are controlled respectively by the control pulses, while the data lines B1 to Bn in the data drive circuit 20 are connected to light-emitting drive voltage Vd1. The control pulse-generating circuit will be described below in detail. The scan drive circuit 30 has ground terminals GND for supplying selected voltage, non-selected voltage terminals Vs, and emission-terminating voltage terminals Vs1, as well as switches S1 to Sn driving the scan lines C1 to Cn respectively to ground potential GND, selected voltage Vs, or emission-termination voltage Vs1.

In the embodiment, the data drive circuit 20 stops supplying light-emitting drive current to multiple data lines B1 to Bn simultaneously at an emission-termination timing in the scanning period and starts supplying light-emitting drive current to data lines B1 to Bn by connecting the data lines B1 to Bn respectively to the light-emitting drive voltage Vd1 at a timing prior by the emission period to the emission-termination timing. Thus, the timing of starting supply of the light-emitting drive current varies according to the gradient value of each light-emitting element, and the supply of the light-emitting drive current is terminated simultaneously at the same emission-termination timing. The scan drive circuit 30 drives the selected scan line C1 to the selected voltage Vs in the scanning period and the selected scan line C1 to an emission-termination voltage Vs1 higher than the selected voltage Vs at the emission-termination timing. As a result, light emission from the light-emitting element is terminated at the emission-termination timing. That is, the emission-termination voltage Vs1 is set to a value in such a way that the voltage applied to the light-emitting element connected to the selected scan line C1 at the emission-termination timing becomes smaller than the emission threshold voltage Vth of the light-emitting element.

Hereinafter, operation of the light emission panel display device in the present embodiment will be described with reference to FIGS. 4 to 7. As shown in FIG. 7, in a vertical synchronization period Vsync, there are multiple horizontal synchronization periods Hsync in the number corresponding to the scanning periods of respective scan lines. The scan line C1 is selected as connected to the ground terminal at time t10 in the first scanning period Hsync1, and the other scan line C2 to Cn are all drived to a reverse biased voltage Vs. The data lines B1 to Bn then are connected to ground potential or are in the floating state FL.

It is assumed now that the light-emitting element A11 has a high gradient value and the light-emitting elements A12 to A1n a gradient value lower than that. As shown in FIG. 4, supply of the light-emitting drive current IL is initiated at time t12, as the control pulse CP1 becomes in the H level and the data line B1 is drived to the light-emitting drive voltage Vd1. The period from initiation of the scanning period Hsync to the emission-initiation timing t12 is determined from the value of the maximum gradient value (e.g., 256) subtracted with the gradient value of the light-emitting element A11. The state in FIG. 4 is preserved during the period from time t12 to t13.

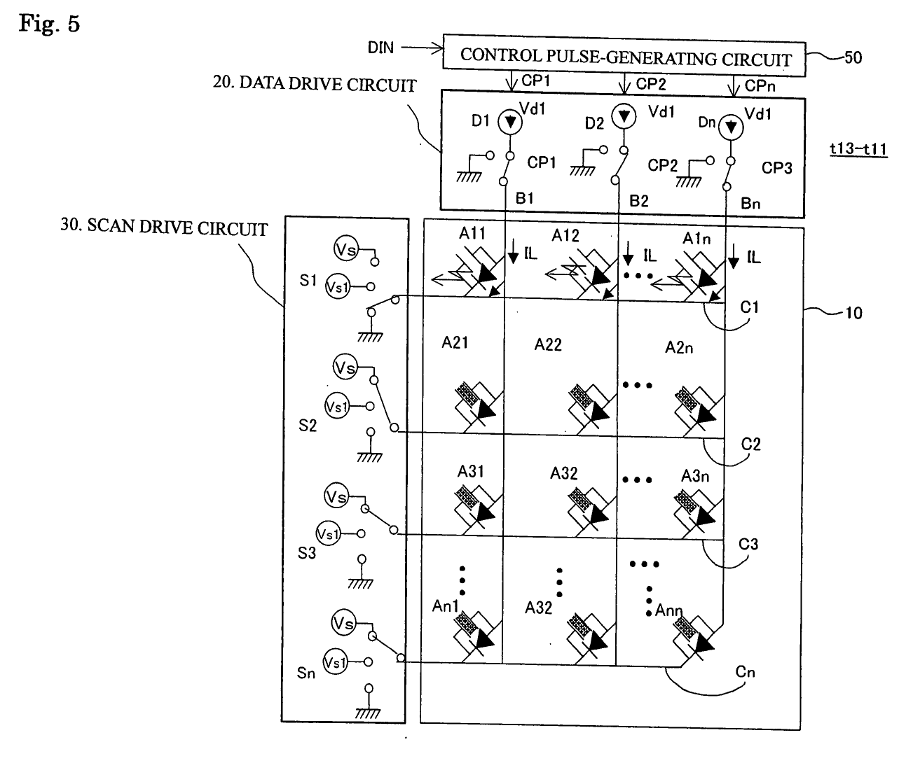

Then as shown in FIG. 5, supply of the light-emitting drive current IL is initiated at a particular time t13 after t12, as the control pulses CP2 to CPn enter in the H level and the data lines B2 to Bn are drived to the light-emitting drive voltage Vd1. The particular time t13 is a timing according to the gradient values of the light-emitting elements A12 to A1n connected to each data lines B2 to Bn. The state in FIG. 5 is preserved during the period from time t13 to t11. During the period, the light-emitting elements A11 to A1n are emitting light by supply of the light-emitting drive current IL, and light-emitting elements connected to unselected scan lines C2 to Cn are charged respectively according to the difference in voltage between reverse biased voltage Vs and light-emitting drive voltage Vd1. In other words, the pulse width PW of each control pulse CP1 to CPn corresponds respectively to the gradient value of the light-emitting element; the control pulse-initiating edges are respectively the timings t12 and t13 in accord with the gradient value of the light-emitting element; and the control pulse-terminating edge is the timing t11 in all light-emitting elements. The data lines corresponding to non-light-emitting elements remain at ground potential or in the floating state.

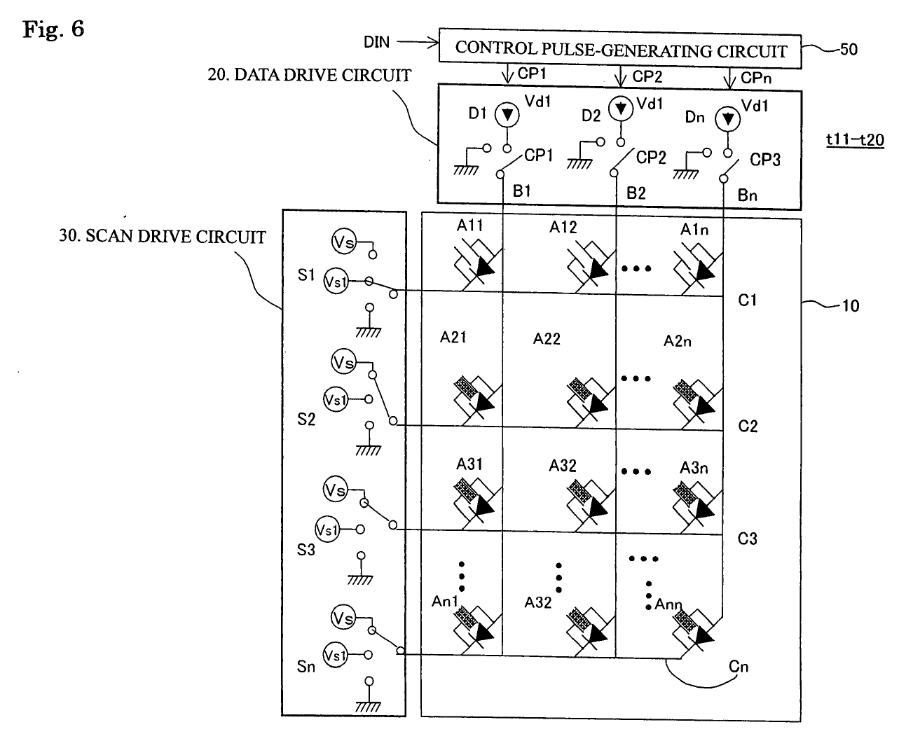

As shown in FIG. 6, the control pulse-generating circuit 50 makes all control pulses CP1 to CPn enter in the L level at the emission-termination timing t11 and stops supply of the light-emitting drive voltage Vd1 and the light-emitting drive current IL to all data lines B1 to Bn. That is, the switches D1 to Dn enter in the high-impedance state, and the data lines B1 to Bn into the floating state FL. In addition, at the emission-termination timing t11, the selected scan line C1 is drived from ground potential to the emission-termination voltage Vs1 higher than that by the scan drive circuit 30. As a result, the light-emitting element connected to the selected scan line stops emitting light.

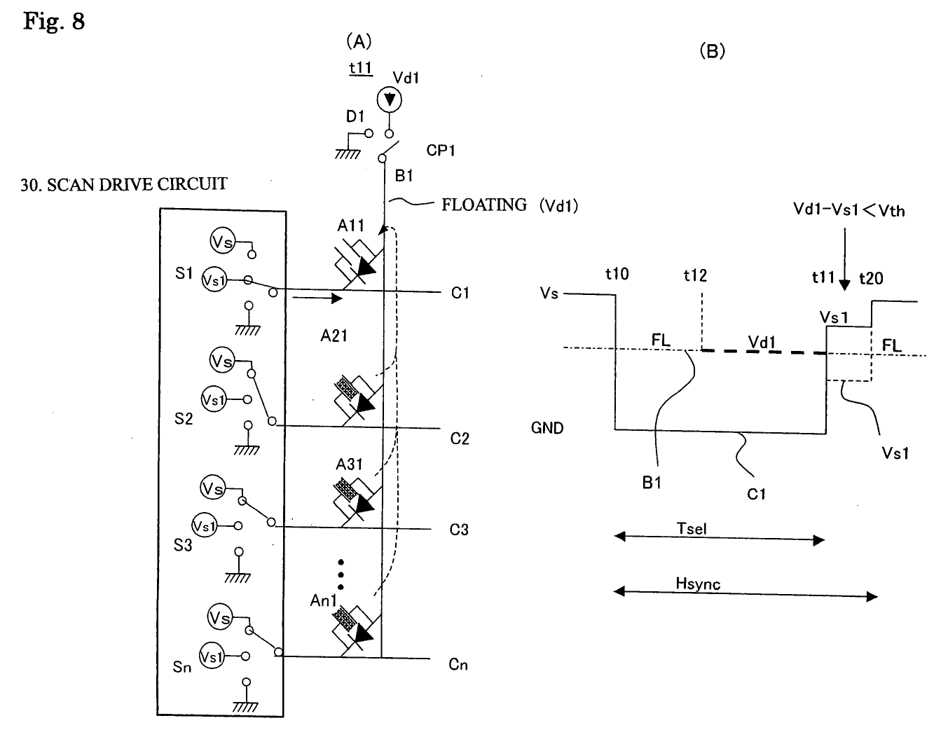

FIG. 8 is a chart showing the operation at the emission-termination timing in the present embodiment. FIG. 8(A) shows the state at the emission-termination timing t11, at which the switch D1 is switched into the off state according to the L level of control pulse CP1 and the data line B1 into the floating state. All unselected scan lines C2 to Cn are drived to the reverse biased voltage Vs in the unselected level, and the selected scan line C1 is drived to the emission-termination voltage Vs1. As shown in the waveform chart in FIG. 8(B), the emission-termination voltage Vs1 is set to a voltage level prohibiting emission of the selected light-emitting element A11, and thus, continued emission of light indicated by a broken line by flow of the charge from the other elements A21 to An1 in unselected state to the element A11 in selected state is avoided. That is, the emission-termination voltage Vs1 is set to a voltage level, at which a voltage of not lower than the threshold voltage, which is needed for light emission by the selected light-emitting element A11, is not applied.

More specifically, the data line B1 is drived to the light-emitting drive voltage Vd1, while the unselected scan lines C2 to Cn to the reverse biased voltage Vs during light emission. And, the data line B1 is switched into the floating state at the emission-termination timing t11, and the selected scan line C1 is drived to the emission-termination voltage Vs1 higher than the selected voltage GND. The capacity of the selected light-emitting element A11 and the parallel capacity of the light-emitting elements A21 to An1 in the unselected state becomes in the state that they are connected in series between the reverse biased voltage Vs and the emission-termination voltage Vs1. Thus, a differential voltage Vs−Vs1 is applied to each capacity at an intensity in reverse parallel with the capacity of the selection light-emitting element A11 and the parallel capacity of the unselected light-emitting elements A21 to An1. As a result, some electric charge is transferred as shown by a broken line in FIG. 8(A). As shown by the broken line Vs1 in FIG. 8(B), when the level of the emission-termination voltage Vs 1 is lower than that of the light-emitting drive voltage Vd1, the data line B1 in the floating state increases toward the reverse biased voltage Vs according to the capacity. In addition, when the emission-termination voltage Vs1 is higher than the light-emitting drive voltage Vd1 as shown by the solid line, the data line B1 in the floating state increases according to the capacity. However in any case, no light is emitted if the voltage applied to the light-emitting element A11 by the charge transfer between the capacities is not higher than its emission threshold voltage. The emission-termination voltage Vs1 is set to such a value that the light-emitting element A11 becomes in the state above.

The emission-termination voltage Vs1 is preferably set, for example, to such a value that the difference thereof from the light-emitting drive voltage Vd1 is not larger than the emission threshold voltage Vth. If the difference between the emission-termination voltage Vs1 and the reverse biased voltage Vs of unselected scan lines is smaller than the emission threshold voltage Vth, no voltage of the emission threshold voltage or more is applied to the selected light-emitting element A11.

In this way, it is possible to reduce the voltage difference (Vs−Vs1) between the unselected scan lines and the selected scan line to a value smaller than the (Vs−GND) in traditional examples, to eliminate significant transfer of electric charge from the unselected light-emitting elements to the selected light-emitting element as in traditional examples, and thus, to avoid light emission by the selected light-emitting element after the emission-termination timing, by driving the selected scan line C1 to a ground potential higher than the emission-termination voltage Vs1 at the emission-termination timing when supply of light-emitting current to the light-emitting elements connected to the selected scan line is terminated at the same time.

Back in FIG. 7, the next scanning period Hsync starts at a time t20, and the next scan line C2 is drived to ground potential and the selected scan line C1 is drived from the emission-termination voltage Vs1 to the reverse biased voltage Vs in the unselected level. Other unselected scan lines C3 to Cn are still maintained at the reverse biased voltage Vs. Supply of the light-emitting drive current to each data line is initiated at the emission-initiation timing corresponding to the gradient value of light-emitting element, and supply of light-emitting drive current to all data lines is terminated at the emission-termination timing t21.

In the present embodiment, there is no need for driving all data line to a third voltage after light emission, and only one selected scan line is drived from ground potential to the emission-termination voltage Vs1 between ground potential and the reverse biased voltage of the next unselected electric potential, and thus, it is possible to prevent undesirable consumption of electric current.

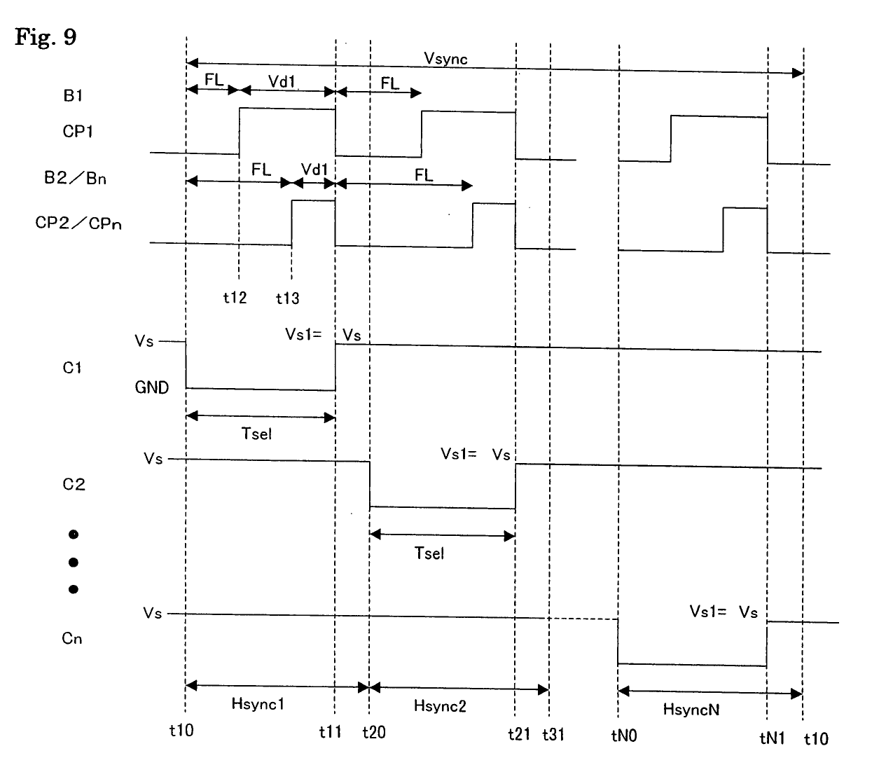

FIG. 9 is chart showing the drive waveform in a modification (1) of the embodiment above. It is different from the chart in FIG. 7 in that the selected scan line C1 is drived to the reverse biased voltage Vs in the unselected level at the emission-termination timing t11. Thus by driving the voltage connected to the selected scan line C1 from ground potential in the selected level to the reverse biased voltage Vs in the unselected level, the selected light-emitting element A11 and the parallel light-emitting elements of unselected light-emitting elements A21 to An1 are short-circuited via the reverse biased voltage Vs, and the voltage between the floating data line B1 and the selected scan line C1 does not become the emission threshold voltage of light-emitting element A11 or more.

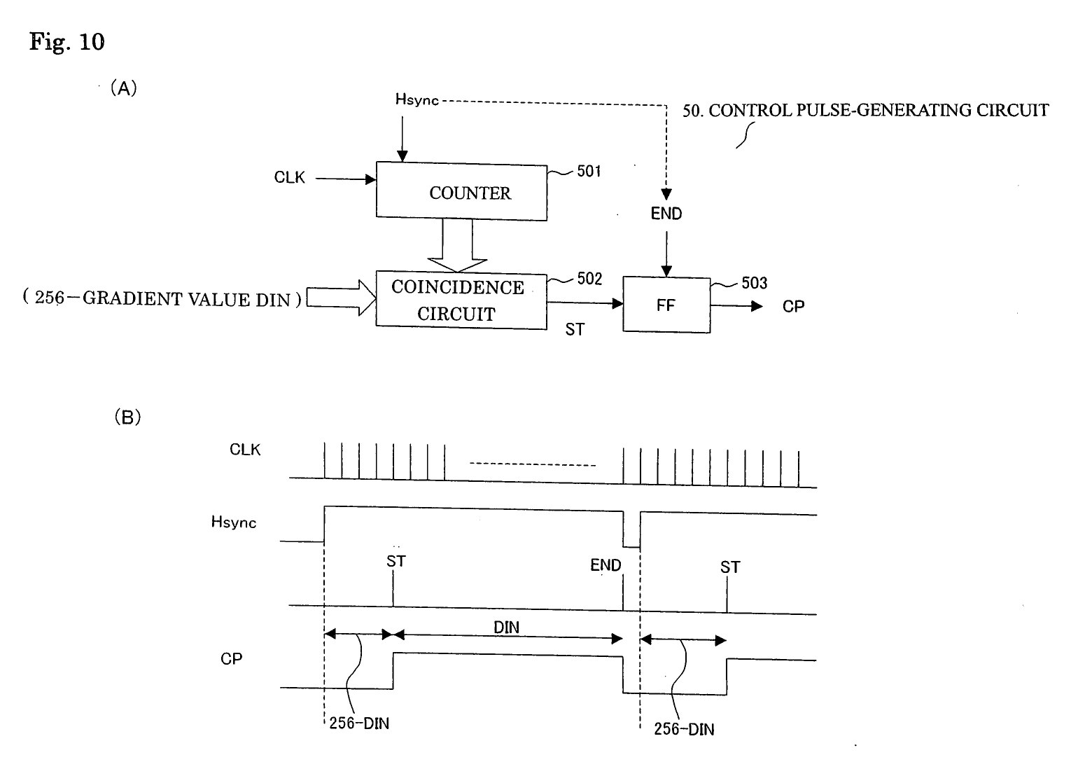

FIG. 10 is a chart showing the control pulse-generating circuit in the embodiment. The control pulse-generating circuit has a counter 501 starting counting with a clock CLK in response to the horizontal synchronizing signal Hsync controlling initiation of scanning period, an coincidence circuit 502 that compares the count with the value of the maximum gradient value 256 subtracted with the inputted gradient value DIN and initiates generating a start pulse ST at the agreement timing, and a flip-flop 503 initiating a control pulse CP in response to the start pulse ST and terminates the control pulse CP in response to the end pulse END corresponding to termination of the horizontal synchronizing signal Hsync.

FIG. 10(B) shows the operational waveform. The counter 501 starts counting with the clock CLK in response to start up of the horizontal synchronizing signal Hsync. When the count reaches a value of the maximum gradient value 256 subtracted with the inputted gradient value DIN, a start pulse ST is generated and a control pulse CP is raised into the H level. The control pulse CP enters in the L level in response to the end pulse END corresponding to the emission-termination timing. In this way, the pulse width of control pulse CP becomes identical with the length corresponding to the inputted gradient value DIN, and the control pulses CP to all data lines become in the L level. The frequency of the clock CLK is set to the maximum gradient value of 256 during the pulse-width period of horizontal synchronizing signal Hsync.

It is possible to terminate light emission of all light-emitting elements connected to the selected scan line at the same timing and also, to make each light-emitting element emit light for the period corresponding to the inputted gradient value DIN, by using the control pulse-generating circuit 50 shown in FIG. 10 in this way.

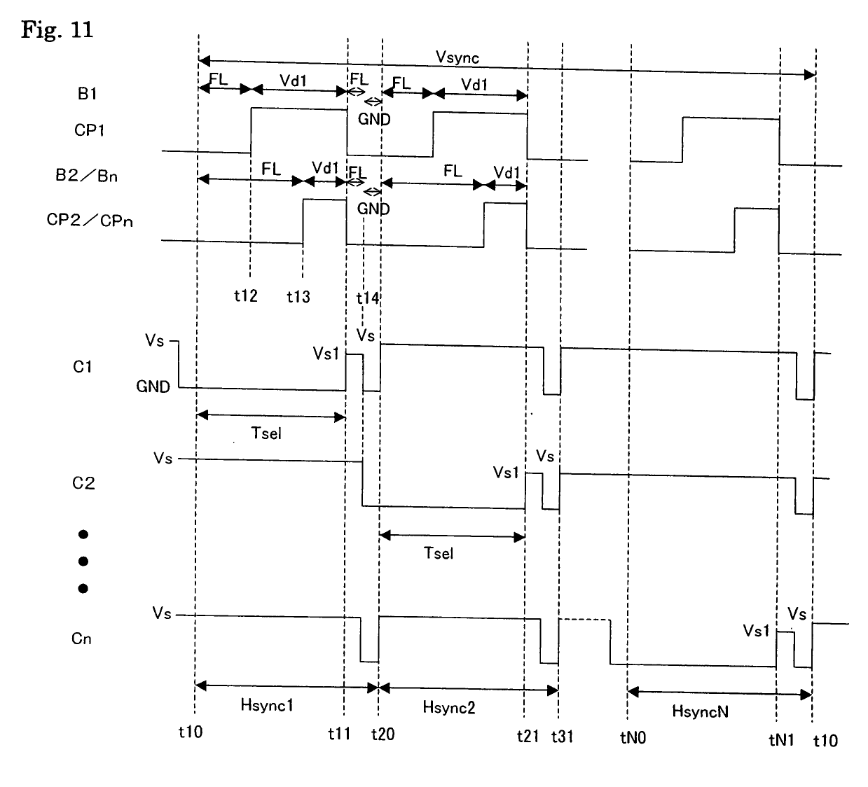

FIG. 11 is a chart showing the drive waveform in another modification (2) of the embodiment above. The driving method is different from the driving method shown in FIG. 7 in that all scan lines C1 to Cn are drived to ground potential, i.e., standard electric potential, and all data lines B1 to Bn are also drived to ground potential after driving the selected scan line C1 to the emission-termination voltage Vs1 at the emission-termination timing t11 and before start of the next scanning period Hsync2 at the time t14. It is possible to discharge and reset all light-emitting elements, by connecting all scan lines and all data lines to ground potential. Thus, a control pulse (not shown in the Figure) for connecting the data lines B1 to Bn to the ground is supplied to the data drive circuit 20.

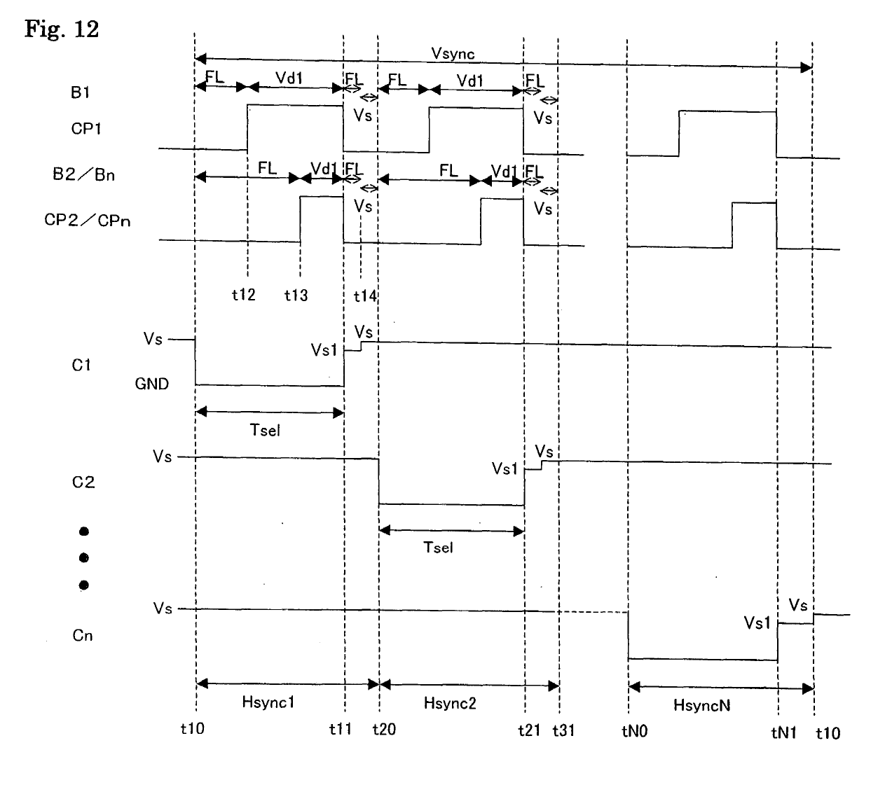

FIG. 12 is a chart showing the drive waveform in yet another modification (3) of the embodiment above. In the embodiment, similarly to that in FIG. 11, the capacity of all light-emitting element is resetted to a particular voltage immediately before initiation of the next scanning period Hsync. However, the reference voltage for resetting all is the voltage Vs in the unselected level of scan line. Specifically, all scan lines are drived to the unselected level Vs for resetting all, and all data lines are also drived to the same voltage Vs. In this way, all light-emitting elements are short-circuited and discharged via the voltage source Vs.

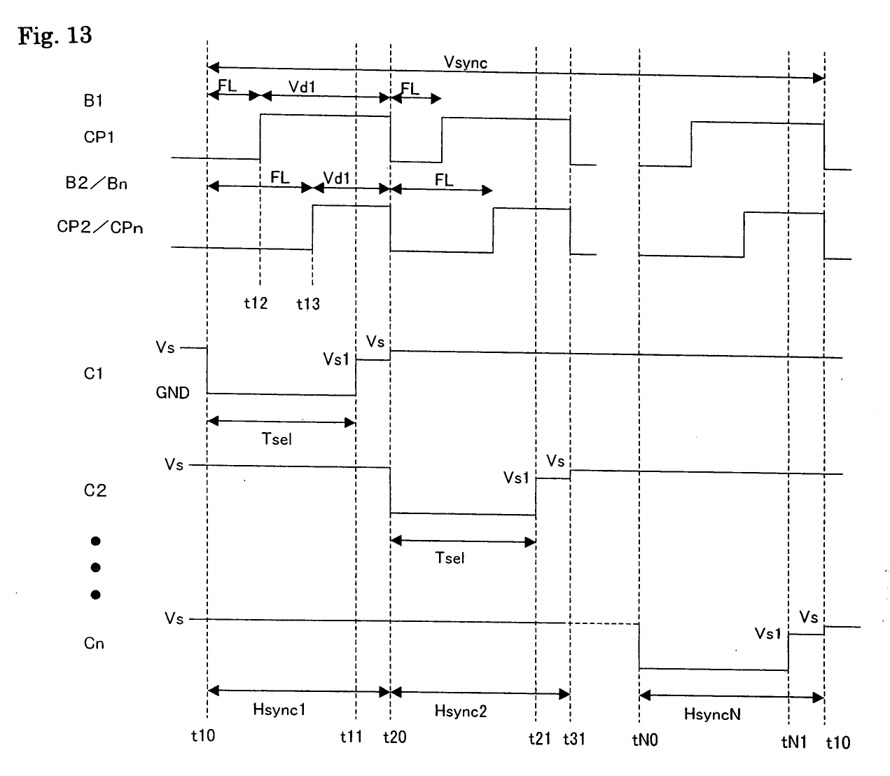

FIG. 13 is a chart showing the drive waveform in yet another modification (4) of the embodiment above. In the modified embodiment, the selected scan line C1 is drived to the emission-termination voltage Vs1 at the emission-termination timing t11, but the data line B1 used for emitting light maintains as it is connected to the light-emitting drive voltage Vd1. However, in such a case, the difference in voltage between the emission-termination voltage Vs1 and the light-emitting drive voltage Vd1 should be kept not larger than the emission threshold voltage Vth of the light-emitting element. Specifically, Vs1−Vd1<Vth. Under the condition satisfying the relationship in voltage above, the light-emitting elements emitting light terminates emission all together in response to driving the selected scan line C1 to the emission-termination voltage Vs1.

In such a case, if there is a light-emitting element not emitting light at all during the scanning period Vsync, the data line corresponding thereto remains at ground potential or in the floating state. When the data line remains to be connected to ground potential, the light-emitting element is only reverse biased and does not emit light, if the selected scan line C1 is drived to the emission-termination voltage Vs1. When the data lines are maintained in the floating state, the floating data lines have a voltage of the reverse biased voltage Vs of unselected scan lines and ground potential of selected scan line divided according to the capacity of the selection light-emitting element and the parallel capacity of the unselected light-emitting elements. When the selected scan line C1 is drived to the emission-termination voltage Vs1 at the emission-termination timing t11 in the state, the electric potential of the floating data lines varies. It is necessary to set the emission-termination voltage Vs1 at a suitable level, for preventing the light-emitting elements connected to the data line from emitting light even when the electric potential varies as described above. Alternatively, a data line not emitting light may be drived to the light-emitting drive voltage Vd1 at the emission-termination timing t11. In such a case, because the voltage of the selected scan line C1 and the emission-termination voltage Vs1 are set to the condition: Vs1−Vd1<Vth, the non-light-emitting element does not emit light.

In the driving method of FIG. 13, the selected scan line C1 may be connected not to the emission-termination voltage Vs1 but to the reverse biased voltage Vs in the unselected level at the emission-termination timing t11. In such a case, the following relationship should be satisfied: Vs−Vd1<Vth. However, the unselected level Vs is set to such a voltage that the all light-emitting elements of unselected scan lines are reverse biased, because of the relationship with the light-emitting drive voltage Vd1. Thus by such operation, all light-emitting element of the selected scan line becomes in the reverse-biased state, similarly to the light-emitting elements of the unselected scan lines.

In the present embodiment described above, supply of the light-emitting drive current to all data lines is terminated at the same time, and the selected scan line is connected to the emission-termination voltage or the unselected level at the same emission-termination timing, and thus, it is possible to reduce consumption of drive current more, compared to the power consumption by conventional methods.

### INDUSTRIAL APPLICABILITY

According to the invention, it is possible to prevent undesirable elongation of light emission of a light-emitting element and improve the gradation characteristics thereof, by terminating supply of light-emitting current to light-emitting elements connected to the same selected scan line all at once and driving a selected scan line to the emission-termination voltage Vs1 or the reverse biased voltage Vs in the unselected level.

What is claimed is:

1. A light emission panel display device, comprising:
a light emitting panel having multiple scan lines, multiple data lines, and capacitive light-emitting elements connected to the data lines and the scan lines at the intersections of the scan lines and the data lines;
a scan drive circuit scanning and selecting the scan lines sequentially and in each scanning period driving the selected scan line to a selected voltage and driving the unselected scan lines to a non-selected voltage higher than the selected voltage; and
a data drive circuit supplying a light-emitting drive current to each data line during the light-emitting period corresponding to each display gradation, wherein
the data drive circuit, in the scanning period, initiates supply of the light-emitting drive current to the data lines at respective emission-initiation timings corresponding to the emission periods and terminates supply of the light-emitting drive current to the multiple data lines at respective emission-termination timings corresponding to the emission periods, and
the scan drive circuit, at the emission-termination timing, maintains the selected scan line to an emission-termination voltage higher than the selected voltage.

2. The light emission panel display device of claim 1, wherein the data drive circuit makes the data line enter into a floating state after the emission-termination timing.

3. The light emission panel display device of claim 1, wherein the emission-termination voltage is the same as the non-selected voltage.

4. The light emission panel display device of claim 1, wherein the difference from the voltage of the light-emitting drive voltage (Vd1) of the data line when driven by the light-emitting drive current to the emission-termination voltage (Vs1) is smaller than the emission threshold voltage of the light-emitting element.

5. The light emission panel display device of claim 1, wherein the scan drive circuit drives the selected scan line with the emission-termination voltage and the voltage applied to the light-emitting element connected to the selected scan line is smaller than the emission threshold voltage.

6. The light emission panel display device of claim 5, wherein the data drive circuit and the scan drive circuit, after the emission-termination timing process and before initiation of the next scanning period, drive the data lines and the scan lines once with a reference voltage and discharge the capacity of the light-emitting elements.

7. The light emission panel display device of claim 6, wherein the reference voltage is the selected or non-selected voltage of the scan line.

8. The light emission panel display device of claim 6, wherein the data drive circuit, after the emission-termination timing, maintains the data line at the light-emitting drive voltage state when driven by the light-emitting drive current, and
the difference in voltage from the light-emitting drive voltage (Vd1) to the emission-termination voltage (Vs1) is smaller than the emission threshold voltage of the light-emitting element.

9. A light emission panel display device, comprising:
a luminescent panel having multiple scan lines, multiple data lines, and capacitive light-emitting elements connected to the data lines and the scan lines at the intersections of the scan lines and the data lines;
a scan drive circuit scanning and selecting the scan lines sequentially and in each scanning period driving the selected scan line at a selected voltage and driving the unselected scan lines at a non-selected voltage higher than the selected voltage; and
a data drive circuit supplying a light-emitting drive current to each data line during the emission period corresponding to each display gradation, wherein:
the data drive circuit, in the scanning period, terminates supply of the light-emitting drive current to the multiple data lines at the same time at the emission-termination timing, and initiates supply of the light-emitting drive current to each data line at the emission-initiation timing that is a timing prior to the emission terminating timing by the respective periods of emission;
the scan drive circuit maintains the selected scan line at the emission-termination voltage at the emission-termination timing; and
the emission-termination voltage is set to such a voltage that at the emission-termination timing the voltage applied to the light-emitting element connected to the selected scan line is smaller than the threshold voltage of the light-emitting element.

10. The light emission panel display device according to claim 1, wherein the data drive circuit makes the data line enter into the floating state after the emission-termination timing.
